(19) United States
(12) Patent Application Publication
(10) Pub. No.: US 2012/0090724 A1
(43) Pub. Date: Apr. 19, 2012

(54) DISPOSABLE FUNNEL

(76) Inventor: Brian Heller, North Bergen, NJ (US)

(21) Appl. No.: 12/907,317

(22) Filed: Oct. 19, 2010

(51) Int. Cl. B67C 11/04; B65B 39/00

(52) U.S. Cl. 141/1; 141/337

(57) ABSTRACT

A disposable funnel used to transfer fluidic, granular or similar material from a first container to a second container. The disposable funnel comprises a resilient, planar paper stock material having a weak adhesive applied to both planar surfaces. Once the funnel is constructed, it is inserted into one container and fluidic or granular material provided in a second container, would be transferred through the use of the funnel. Once the transfer has been completed, the funnel can be removed from the first container and then discarded. The disposable funnel could be constructed utilizing a static vinyl material instead of the resilient, planar paper stock material, thereby forming the funnel without the utilization of the weak adhesive material.

### FIELD OF THE INVENTION

The present invention relates to a funnel used to transfer granular and/or fluidic material from a first container to a second container.

### BACKGROUND OF THE INVENTION

Funnels have been in use for a relatively long period of time, generally to transfer granular or fluidic material from a first generally larger container into a second generally smaller container. Historically, the funnel is usually conical in shape, having a relatively large end of a first diameter which would then taper into a second end having a much smaller diameter. These funnels are usually constructed from a plastic or metallic material.

However, rather recently the materials of which a funnel is constructed have changed, allowing a plastic or paper-like material to be utilized for the funnel. For example, U.S. Pat. No. 5,078,189, issued to Ronsonet, illustrates an adjustable funnel apparatus comprising a flat, rectangular sheet member constructed from a flexible material, such as plastic or the like. A first raised locking member runs substantially along the width of one face of the resilient material and a second raised locking member runs a distance along another edge of the sheet, this second locking member being substantially perpendicular to the first locking member. The use of these locking members would allow a formed funnel to maintain its shape.

U.S. Pat. No. 5,121,779, issued to Green, also describes a funnel comprising a flat sheet of resilient, flexible material. A pair of inter-engaging formations on opposite sides of the flat sheet would allow the funnel to maintain its particular configuration.

U.S. Pat. No. 4,896,707, to Cowles, describes an adjustable, disposable funnel constructed from a generally rectangular-shaped sheet of flexible material. A corner of the material is eliminated and an adhesive strip, overlaid by a cover, is provided at this corner. As shown in FIG. 7, a kit is provided comprising a quantity of these sheets included in a container. When used, one of the strips is removed from the container and the use of the adhesive strip would allow a funnel to be produced as shown in FIGS. 3-5 from the flexible material. The funnel is then inserted into an input orifice of a container.

U.S. Patent Application Publication 2002/0038677, to Wiethoff, describes a disposable funnel similar in many respects to the funnel described in the Cowles patent. This disposable funnel includes an adhesive strip, provided under a release coating strip, as shown in FIG. 2. FIG. 3 illustrates use of two strip materials on the edge of a planar-angular substrate. FIG. 1 shows the tunnel being inserted into a container.

U.S. Pat. Nos. 7,237,583, 7,240,701 and 7,383,863, all issued to Salani et al., describe various collapsible funnels. The '701 and '863 patents utilize a glue strip adjacent to one end of a planar sheet to produce a funnel, wherein Salani et al. '583 does not employ this glue strip.

While all of the funnels shown in the above-noted U.S. publication and patents would allow material from a first container to be transferred into a second container, none of these funnels are provided with an adhesive surface on both sides of a flexible planar sheet of material, allowing the funnel to be positively maintained in the outlet orifice of the second container into which fluidic or granular material is to be transferred.

### SUMMARY OF THE INVENTION

The present invention overcomes the deficiencies of the prior art by providing a resilient, planar, paper stock sheet from which a funnel is constructed. In one embodiment, a relatively weak adhesive such as the adhesive used in the POST-IT® notes manufactured by 3M is applied to a portion of the surface area of both sides of the resilient planar material. This would allow the planar material to be folded upon itself, as will be illustrated, into a conical shape having a top opening having a diameter much larger than the diameter of a bottom opening. The funnel so constructed would then be inserted into an input/output orifice of a first container into which granular or fluidic material is to be transferred. A second embodiment would employ the use of a flexible planar static vinyl sheet to produce the funnel. In this embodiment, no adhesive would be applied to the static vinyl sheet, since static electricity would be used to allow the funnel to be formed and to remain in place when the granular or fluidic materials are transferred. The flexible planar material of both embodiments can be in various forms such as, but not limited to, a square, rectangle, semicircle, pentagon, hexagon or octagon.

A second container in which the fluidic or granular material is stored is tilted in such a manner allowing the granular or fluidic material to flow from this first transferor container into the larger diameter opening of the funnel and then into the input/output orifice of the second transferee container. Alternatively, the first container could be standing upright and the second container angled 180° with regard to the surface on which the first container stands when the fluidic or granular method is poured from the second container into the first container. Although it is not required, presumably the transferee container would have fluidic or granular material already provided therein prior to the fluidic or granular material to be transferred from the transferor container. Due to the use of a weak adhesive material on the outer surface as well as the inner surface of the flexible planar paper stock material, the lower end of the funnel would adhere to the inner surface of the inlet/outlet portion of the transferee container, thereby maintaining the conical funnel in position removably attached to the transferee container. Once the transfer of material is completed, the funnel is removed from the transferee container and can be discarded. Similarly, use of the flexible planar static vinyl material would maintain its conical shape when the granular or fluidic material is transferred between the two containers, as well as maintaining the funnel in position with the transferee container.

An embodiment of the present invention would provide a plurality of the flexible planar paper stock material in a book-like form. Therefore, when the use of a funnel is required, a top sheet of the book-like form is easily removed therefrom to construct the disposable funnel. Alternatively, the book-like form could itself be provided within a container for ease of use and transportability.

### BRIEF DESCRIPTION OF THE DRAWINGS

The present invention will be more fully understood from the following, detailed description of the preferred embodiments thereof, taken together with the drawings, in which:

FIG. 1 is a planar view of one of the flexible planar paper-type stock used to produce a funnel;

FIG. 2 is a side elevational view of the present invention in a funnel shape;

FIG. 3 is a top view of the funnel shown in FIG. 2;

FIG. 4 shows liquid or granular material being transferred from one container to a second container;

FIG. 5 is a side elevational view of a stack of resilient planar paper stock material in book form;

FIG. 6 is a planar view of a second flexible planar paper-type stock with a varying arrangement of applied adhesive than is shown in FIG. 1 used to produce the funnel; and

FIGS. 7-13 are planar views of various shapes of both flexible paper-type stock as well as flexible static vinyl material used to form the funnel.

### DETAILED DESCRIPTION OF THE PRESENT INVENTION

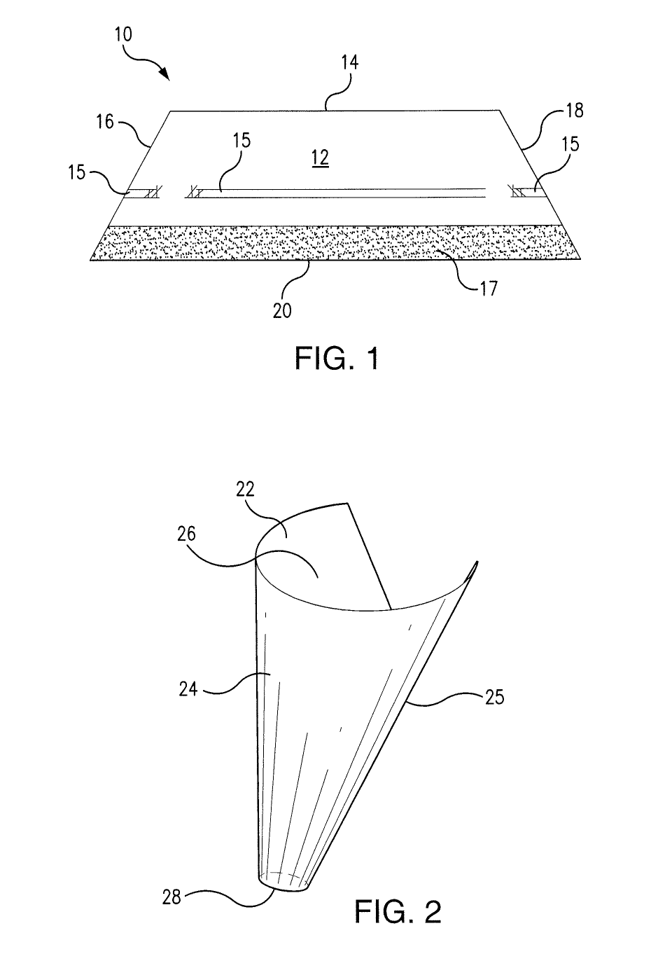

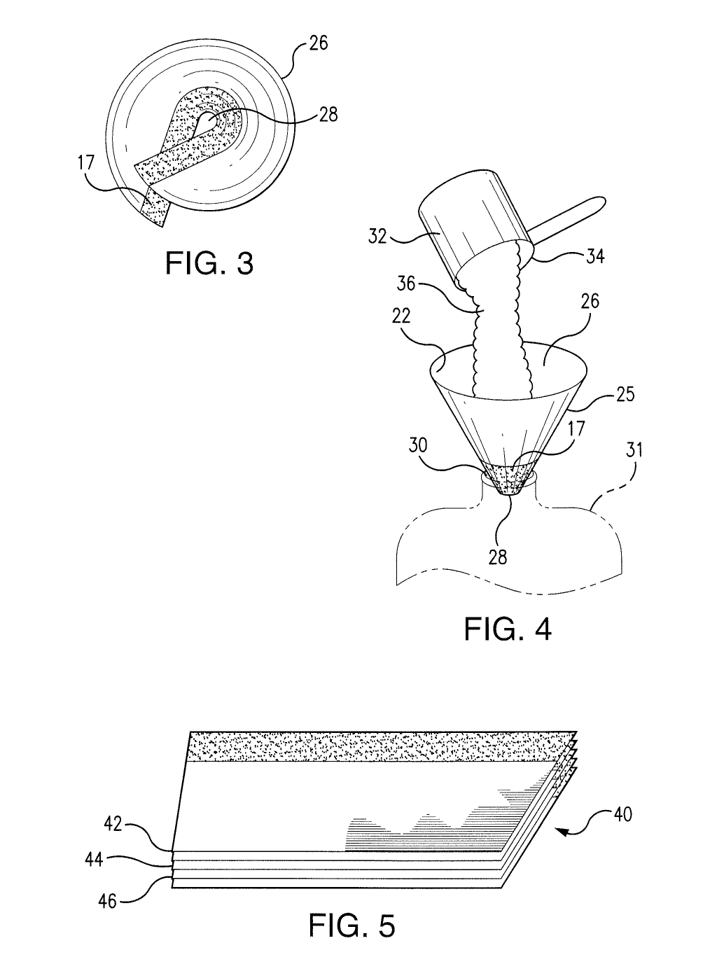

FIG. 1 shows a first embodiment of the present invention 10 which includes a relatively resilient planar paper stock material 12 from which a disposable funnel, as shown in FIG. 2, would be produced. As shown in FIG. 1, the material 12 is rectangular trapezoidal in form and includes a top base 14 and a bottom base 20 possibly longer in length than the top base 14. Angled sides 16 and 18 would connect the bases 14 and 20 together. The use of a rectangular trapezoidally-shaped planar material lends itself particularly well to the present invention since when the resilient planar material is folded, as shown in FIGS. 2, 3 and 4, the top base 14 as well as the two sides 16 and 18 would form a top opening 26 having a diameter greater than the diameter 28 of the bottom of the funnel which is conical in shape. When constructed, the funnel would also include an inner surface 22. As shown in FIG. 2 or 3, the planar outer surface 24 of the funnel 25, between the top opening 26 and the bottom opening 28, would taper. Although FIG. 1 shows use of a flexible planar paper stock material in the form of a trapezoid, it can be appreciated that other shapes of planar material can be utilized such as a square, rectangle, circle, semicircle, pentagon, octagon, hexagon, or the like.

It is important to note that both the inner surface 22 and the outer surface 24 of the resilient planar paper stock material is coated with a relatively weak adhesive material for at least a portion of each side of the planar paper stock material. As shown in FIG. 1, the adhesive material 17 would coat one of the base portions 20, from end to end of the base and extend for approximately ½ inch to 1½ inches from the edge of the base 20 toward the center of the paper stock, on both the inner surface 22 and the outer surface 24.

FIG. 4 shows the manner in which the disposable funnel 25 is to be utilized. When a funnel is to be constructed, instructions 15, provided on one or both of the surfaces of the resilient planar paper stock material 12, would instruct the user where and how to fold one of the sides of the resilient planar paper stock material 16 or 18 over its opposite side to produce a conical structure, as shown in FIG. 2, having a first opening 26, having a larger diameter than the second opening 28. The use of the weak adhesive material 17 on both surfaces 22 and 24 would ease in the construction of the funnel since these surfaces would adhere to one another.

When in use, as shown in FIG. 4, the lower smaller diameter opening 28 is inserted into an orifice 30 of a container 31, such as a bottle or other type of container, into which fluidic or granular material 36 is to be transferred. This material is contained in a larger container such as a scooper 32 having an inlet/outlet orifice 34 through which the fluidic or granular material 36 would flow into the larger diameter opening 26, through the funnel 25, into the orifice 30 of the container 31 and into the interior of that container. It is presumed, but not necessarily so, that the container 31 would have granular or fluidic material which would then mix with the granular or fluidic material 36 transferred from the generally larger container 32 into the generally smaller container 31.

Once the transfer is completed, the conical funnel 25 is removed from the orifice 30. Initially, when the funnel 25 was inserted into the orifice 30, since the exterior surface of the conical funnel 25 has a weak adhesive material 17 provided thereon, it would adhere to the inner surface of the orifice 30, allowing the funnel to be attached to the orifice 30, thereby easing the transfer of the fluidic or granular material 36 from the transferor container 32 to the transferee container 31. Thereafter, once the transfer of fluidic or granular material is completed, the funnel 25 can be easily removed from the orifice 30 of container 31 and discarded.

FIG. 5 shows the use of a plurality of resilient planar paper stock material 10 produced in book form 40. This book would contain a plurality of sheets of resilient planar paper stock material 42, 44 and 46. When a user wishes to create the disposable funnel, they would merely remove the top sheet 42 from the book and construct the funnel in the manner described hereinabove.

This book can also be manufactured in a staggered arrangement for ease of separation of the sheets of the back from one another. In this manner, the adhesive material 17 of a first sheet would not abut the adhesive material 17 on adjacent sheet.

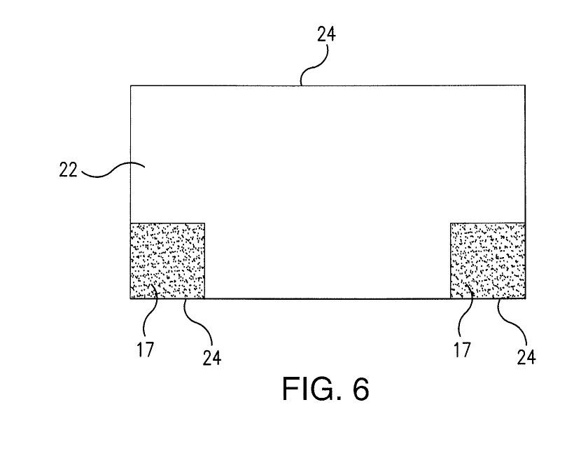

FIG. 6 illustrates another embodiment of the present invention in which the adhesive 17 is located on two corners of the outer surface 22. Although not shown, the adhesive 17 would be provided on two corners of the inner surface 24, in the same corners as the adhesive 17 coating a portion of the outer surface 32. Additionally, it is noted that the paper stock material is in the shape of a rectangle.

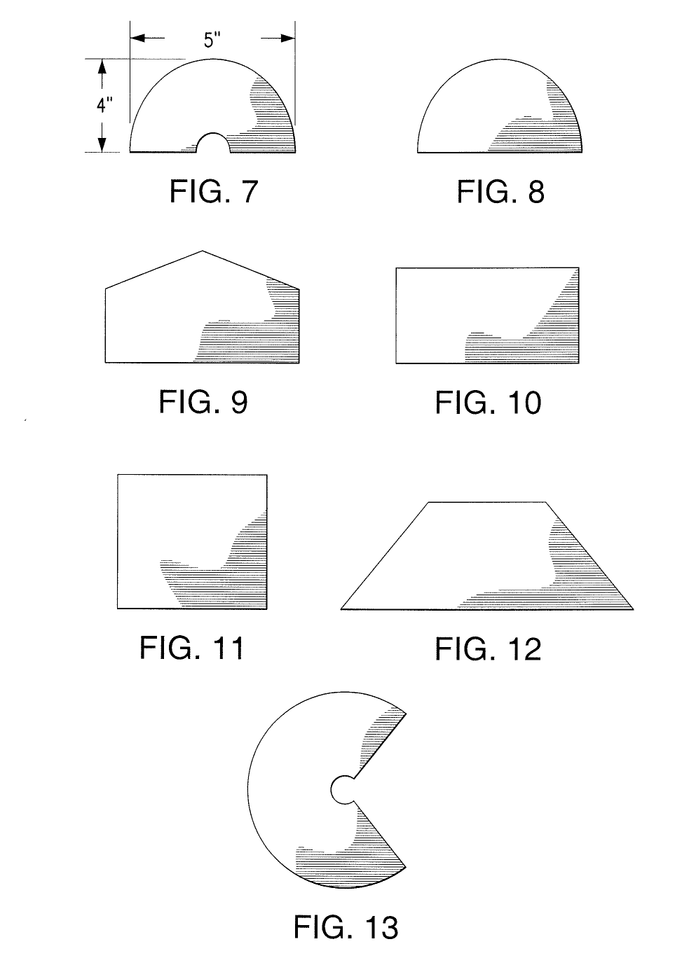

FIGS. 7-13 illustrate the second embodiment of the present invention which utilizes a sheet of flexible static vinyl material to produce the funnel. The use of this particular material would eliminate the requirement of the first embodiment of the present invention which coats a portion of the planar-type stock material with an adhesive to produce the funnel. FIGS. 7-13 show different shapes of material that can be used to form the funnel. However, it is important to note that other shapes of the flexible planar static vinyl material can be employed to produce the funnel. Additionally, the shape shown in FIGS. 7-13 can be used with the first embodiment of the present invention which does coat a portion of the planar-type stock material with an adhesive coating.

Similar to the first embodiment of the present invention, the funnel is formed by folding one of the sides of the static vinyl material over its opposite side to produce a conically shaped funnel.

It would be appreciated by a person skilled in the art that the present invention is not limited to what has been particularly shown and described hereinabove. Rather, the scope of the present invention includes both combinations and sub-combinations of the various features described hereinabove, as well as variations and modifications thereof that are not in the prior art, which would occur to persons skilled in the art upon reading the foregoing description.

What is claimed is:

1. A disposable funnel comprising a flexible planar stock material provided with an inner surface and an outer surface, a portion of both said inner surface and said outer surface coated with a relatively weak adhesive, wherein a funnel shape is formed having a top opening and a bottom opening, said top opening having a diameter greater than the diameter of said bottom opening, said funnel shape being formed when a portion of said inner surface is positioned over a portion of said outer surface, allowing said funnel shape to be maintained by said relatively weak adhesive.

2. The disposable funnel in accordance with claim 1, wherein only a lateral side of said inner surface and only a lateral side of said outer surface is coated with said relatively weak adhesive, said relatively weak adhesive extending for a width of between ½ inch and 1½ inches from one lateral edge of said inner surface and one lateral edge of said outer surface.

3. The disposable funnel in accordance with claim 1, wherein said flexible planar stock material is in the form of a trapezoid.

4. The disposable funnel in accordance with claim 1, wherein said flexible planar stock material is in the form of a square, rectangle, semicircle, circle, pentagon, hexagon or octagon.

5. The disposable funnel in accordance with claim 1, wherein said outer surface has printing thereon instructing a user how to form said funnel.

6. The disposable funnel in accordance with claim 1, further including a plurality of said flexible planar stock material stacked on top of one another to form a book of said flexible planar stock material, stacked straight or staggered.

7. The disposable funnel in accordance with claim 1, wherein said relatively weak adhesive is applied only to two corners of said inner surface and two corners of said outer surface.

8. A disposable funnel comprising a flexible planar static vinyl material provided with an inner surface and an outer surface, wherein a funnel shape is formed having a top opening and a bottom opening, said top opening having a diameter greater than the diameter of said bottom opening, said funnel shape being formed when a portion of said inner surface is positioned over a portion of said outer surface, allowing said funnel shape to be maintained by the static electricity of said static vinyl material.

9. The disposable funnel in accordance with claim 8, wherein said flexible planar static vinyl material is in the form of a trapezoid.

10. The disposable funnel in accordance with claim 8, wherein said flexible planar static vinyl material is in the form of a square, rectangle, semicircle, circle, pentagon, hexagon or octagon.

11. The disposable funnel in accordance with claim 8, wherein said one surface of said static vinyl has printing thereon instructing a user how to form said funnel.

12. A method of transferring fluidic or granular material from a first container to a second container having an orifice comprising the steps of:
forming a funnel from a flexible planar stock material provided with an inner and outer surface coated with a relatively weak adhesive over a portion of both the inner and outer surface, wherein a funnel shape is formed having a top opening and a bottom opening, said top opening having a diameter greater than the diameter of said bottom opening, said funnel shape being formed when a portion of said inner surface is positioned over a portion of said outer surface, allowing said funnel shape to be maintained by said relatively weak adhesive;
inserting said funnel into the second container, allowing a portion of said outer surface close to said bottom opening to contact an inner surface of the second container close to the orifice, wherein said relatively weak adhesive maintaining said funnel within the orifice; and
pouring fluidic or granular material provided within the first container through said funnel and into the second container.

13. A method of transferring fluidic or granular material from a first container to a second container having an orifice comprising the steps of:
forming a funnel from a flexible planar static vinyl material provided with an inner and outer surface, wherein a funnel shape is formed having a top opening and a bottom opening, said top opening having a diameter greater than the diameter of said bottom opening, said funnel shape being formed when a portion of said inner surface is positioned over a portion of said outer surface, allowing said funnel shape to be maintained by the static electricity of said static vinyl material;
inserting said funnel into the second container, allowing a portion of said outer surface close to said bottom opening to contact an inner surface of the second container close to the orifice; and
pouring fluidic or granular material provided within the first container through said funnel and into the second container.
